(19) United States
(12) Patent Application Publication
(10) Pub. No.: US 2020/0283629 A1
(43) Pub. Date: Sep. 10, 2020

(54) MQ SILICONE RESINS

(71) Applicant: Dow Silicones Corporation, Midland, MI (US)

(72) Inventors: Zhi Li, Audubon, PA (US); Thomas D. Bekemeier, Birch Run, MI (US); Bartley D. Maxon, Midland, MI (US); Kimmai T. Nguyen, Midland, MI (US); Randall G. Schmidt, Kewadin, MI (US); Gary M. Wieber, Midland, MI (US); Xianghuai Wang, Midland, MI (US)

(21) Appl. No.: 16/488,272

(22) PCT Filed: May 1, 2018
(86) PCT No.: PCT/US2018/030336

§ 371 Date: Aug. 23, 2019

Related U.S. Application Data
(60) Provisional application No. 62/515,068, filed on Jun. 5, 2017.

(51) Int. Cl. C08L 83/08; C08G 77/455; C08G 77/00

(52) U.S. Cl. CPC C08L 83/08; C08G 77/70; C08G 77/455

(57) ABSTRACT

A composition comprising an MQ resin having a silanol index no greater than 300 and a polysiloxane having a viscosity of at least 600,000 cSt at 25° C. or a solid silicone polyamide.

This invention relates to a composition comprising MQ resin which is useful in cosmetic applications.

Silicone compositions comprising a silicone gum (high-viscosity diorganopolysiloxane) are known for use in cosmetic applications, see, e.g., U.S. Pat. No. 6,139,823. However, the known compositions do not provide good transfer resistance and sebum resistance.

### STATEMENT OF THE INVENTION

The present invention provides a composition comprising:
a) MQ resin having a silanol index no greater than 300; and
b) a polysiloxane having a viscosity of at least 600,000 cSt at 25° C. or a solid silicone polyamide.

### DETAILED DESCRIPTION

Percentages are weight percentages (wt %) and temperatures are in ° C. unless specified otherwise. Operations were performed at room temperature unless specified otherwise. As used herein, unless otherwise indicated, molecular weights, Mₙ, M_{w} and M_{z} have the conventional meanings and are determined by gel permeation chromatography. Molecular weights are reported herein in units of g/mol. Silanol index is determined by FT-IR as described in the Examples. A “solid” material is one that is solid at 25° C.

An “MQ resin” is a polysiloxane comprising units of [SiO_{4/2}] (Q units) and nonpolar units of [RR′R″SiO_{1/2}] (M units), wherein R, R′ and R″ independently are C₁-C₁₂ alkyl, C₂-C₁₂ alkenyl or C₆-C₁₂ aryl; preferably C₁-C₆ alkyl, C₂-C₆ alkenyl or C₆-C₁₀ aryl; preferably C₁-C₄ alkyl, C₂-C₄ alkenyl or C₆-C₉ aryl; preferably methyl, vinyl or phenyl; preferably methyl. An aryl group may be substituted by one or more alkyl groups. The carbon number for the aryl group includes carbon atoms in any alkyl substituent(s). Preferably, the MQ resin has no [RR′SiO_{2/2}] (D) or [RSiO_{3/2}] (T) units. Preferably, the M/Q ratio is from 0.5:1 to 1.1:1, preferably from 0.6:1 to 1.0:1, preferably from 0.7:1 to 0.95:1. Preferably, the silanol index of the MQ resin is no more than 270, preferably no more than 240, preferably no more than 220; preferably at least 10, preferably at least 50.

Preferably, the composition comprises from 1 to 40 wt % MQ resin having a silanol index no greater than 300 and from 0.1 to 30 wt % polysiloxane or silicone polyamide, based on total weight of the composition; preferably from 2 to 30 wt % MQ resin and from 0.5 to 25 wt % polysiloxane and/or polyamide, preferably from 5 to 20 wt % MQ resin and from 1 to 18 wt % polysiloxane and/or polyamide.

MQ resin having a silanol index no greater than 300 can be prepared directly from M and Q precursors in a suitable ratio (see, e.g., U.S. Pat. Nos. 2,814,601, 2,857,356) or from a commercially available MQ resin having a higher silanol index by capping at least a portion of the silanol units with M units.

Preferably, the polysiloxane or silicone polyamide having a viscosity of at least 600,000 cSt at 25° C. has a viscosity of at least 800,000 cSt at 25° C., preferably no more than 10,000,000 cSt, preferably no more than 5,000,000 cSt.

The fluid polysiloxane polymers of the present invention comprise repeating units, wherein said units correspond to the formula [RR′SiO_{2/2}] (D units), where R and R are monovalent hydrocarbon radicals containing from 1 to 6 carbon atoms, preferably selected from the group consisting of methyl, ethyl, propyl, isopropyl, butyl, isobutyl, t-butyl, amyl, hexyl, vinyl, allyl, cyclohexyl, phenyl, fluoroalkyl and mixtures thereof. The polysiloxane fluids employed in the present invention may contain one or more of these hydrocarbon radicals as substituents on the siloxane polymer backbone. The polysiloxane fluids may be terminated by triorganosilyl groups of the formula (R″₃Si) where R″ is a radical selected from the group consisting of monovalent hydrocarbons containing from 1-6 carbon atoms, hydroxyl groups, alkoxyl groups and mixtures thereof.

A silicone polyamide is a copolymer having both siloxane units and amide units. Preferably, the silicone polyamide comprises blocks, each of which comprises a polysiloxane block and an amide. Preferably the amide comprises polymerized units of an amine having 1-40 carbon atoms, preferably 1-20.

Preferably, the silicone polyamide has formula A

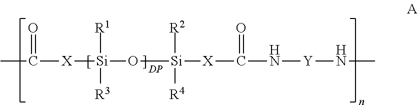

wherein:
(1) DP is 1-700, preferably 15-500, preferably 15-45. In this context, DP represents an average value for degree of polymerization of the siloxane units as shown in Formula A with this average being a number average based on all the siloxane segments in all units of Formula A in the material considered.
(2) n is a number from 1-500, preferably 1-100, preferably 4-25;
(3) X is a divalent, aliphatic hydrocarbon group having 1-30 carbons, preferably 3-10 carbons, preferably 7-10 carbons;

### (4) Y is:

(a) a divalent hydrocarbon group having 1-40 carbons, preferably 1-20 carbons, preferably 2-6 carbons, preferably 5-6 carbons, wherein the hydrocarbon group itself may optionally and additionally be substituted by at least one member selected from the group consisting of (i) hydroxy; (ii) a C₃-C₈ cycloalkyl; (iii) 1-3 members selected independently from the group consisting of C₁-C₃ alkyl and phenyl optionally substituted by 1-3 members selected independently from the group consisting of C₁-C₃ alkyl; (iv) a C₁-C₃ hydroxyalkyl; and (v) a C₁-C₆ alkyl amino, and
the hydrocarbon group may optionally and additionally contain at least one of (i) 1-3 amide linkages; (ii) a C₅ or C₆ cyclic, divalent, saturated hydrocarbon group; and (iii) a phenylene optionally substituted by 1-3 members selected independently from the group consisting of C₁-C₃ alkyls, or
(b) R²⁰T(R²¹)R²², where R²⁰ and R²² are divalent C₁-C₁₀ hydrocarbon groups and R²¹ is a monovalent or divalent C₁-C₁₀ hydrocarbon group, such groups being independent of one another, and T is C(R), where R is selected from hydrogen, R¹, R², R³, R⁴, or a trivalent N, P or Al; the divalencies and trivalencies herein should be understood and taken to allow for branching, cross linking or the like in certain instances and as appropriate; and
(5) Each of R¹-R⁴ is independently selected from the group consisting of methyl, ethyl, propyl, isopropyl, a siloxane chain (such as a polydimethylsiloxane or a siloxane based polyamide), and phenyl, wherein the phenyl may optionally be substituted at 1-3 positions by substituents independently selected from the group consisting of methyl and ethyl; more particularly, each of R¹-R⁴ is selected from methyl and ethyl, preferably methyl.

The composition may further comprise 0.5 to 50 wt % of coloring agent(s) (preferably 5 to 45, preferably 10 to 40), 0.1 to 60 wt % volatile solvent(s) (e.g., water, ethanol, C₈-C₁₈ hydrocarbons) (preferably 5 to 50, preferably 10 to 40) having viscosity of 0.5 to 50 cp at 25° C. (see U.S. Pat. No. 6,464,964 for examples of other volatile solvents).

### EXAMPLES

Formulations

Several sets of color formulations were prepared to study impacts of MQ resin's silanol content to performance. Table 1 shows a set of formulations comprise MQ resin (varying Silanol Index value), silicone gum, isododecane as volatile carrier fluid, and pigment, and have a 7.5:2.5 MQ to silicone gum ratio (wt). Table 2 shows a set of formulations comprise MQ resin, silicone gum, isododecane as volatile carrier fluid, and pigment, and have a 6:4 MQ to silicone gum ratio (wt). Table 3 shows a set of formulations comprise MQ resin, silicone polyamide, isododecane as volatile carrier fluid, and red pigment.

TABLE 1
Anhydrous Formulations containing MQ resin and Silicone
Gum at 7.5:2.5 MQ resin to Silicone Gum ratio (wt).

| | |
|---|---|
| Isododecane | 50% |
| Different MQ resins with different Silanol | 31.86% |
| Index values | |
| Xiameter pmx-200 1 million cst silicone gum¹ | 10.62% |
| Red Lake 7 | 7.52% |

¹polydimethylsiloxane

TABLE 2
Anhydrous Formulations containing MQ resin and Silicone
Gum at 6:4 MQ resin to Silicone Gum ratio (wt)

| | |
|---|---|
| Isododecane | 50% |
| Different MQ resins with different Silanol | 25.50% |
| Index values | |
| Xiameter pmx-200 1 million cst silicone gum | 16.98% |
| Red Lake 7 | 7.52% |

TABLE 3
Anhydrous Formulations containing MQ resin and
Silicone Polyamide

| | |
|---|---|
| Isododecane | 50% |
| Different MQ resins with different Silanol | 29.4% |
| Index values | |
| Dow Corning 2-8179 Silicone Polyamide² | 12.6% |
| Red Iron Oxides Pigment (DHL-R-77491 | 8% |
| Dimethicone treated, from US Cosmetics) | |

²nylon 611/dimethicone copolymer

### Silanol Index Measurement:

An MQ resin's Silanol Index for MQ's non-hydrogen bonded surface SiOH is a value used to define a siloxane material's surface SiOH content. The lower an MQ resin's Silanol Index value, the lower surface SiOH content, thus the lower polarity enhancement. Silanol Index is defined by the following procedure involving FT-IR measurement and a subsequent data processing.

First, a MQ in Carbon Tetrachloride solution was prepared. Accurate MQ concentration (weight to solvent volume) is obtained: for instance, dissolving 0.05 gram in 3 ml Carbon Tetrachloride resulted in a 1.67% (w/v ratio) MQ solution. FT-IR spectrum can then be obtained by scanning ˜3 ml MQ solution in an IR quartz cuvette with 1 cm optical pathway. A 64-scan is performed with a 4 cm-1 spectral resolution.

Second, a reference spectrum of the same MQ sample is obtained using the same procedure described above, except that labile hydrogen atoms have been exchanged with deuterium. The deuterium exchange occurs by adding 0.5 ml D₂O to MQ solution in IR cell, shaking vigorously for 30 seconds, and allowing the phases to separate. Removed the D₂O layer and repeated with a fresh 0.5 ml of D₂O. Conducted IR scan after the above procedure was completed.

Third, a defined data processing procedure was applied to obtain MQ resin OH groups' IR bands. This procedure started with subtracting the reference spectrum spectrally from the sample spectrum to remove all invariant features. The water absorbances near 3710 and 3610 cm⁻¹ were then removed by spectrally subtracting a permanently stored spectrum of water in Carbon Tetrachloride. The water in Carbon Tetrachloride spectrum was created by spectrally subtracting a scan of dry Carbon Tetrachloride from a scan of water-saturated Carbon Tetrachloride. The resulted final IR spectrum consisted only of OH bands from the MQ resin.

Finally, in the final FT-IR spectrum OH signal peak around 3700 cm−1, assigned to non-hydrogen bonded surface SiOH, is integrated to obtain OH Signal Area. Particularly, the Silanol Index value in this patent application is defined as: Silanol Index=OH Signal Area around 3700 cm−1/MQ solution's concentration (w/v ration, in %). For instance, for a 1.67% (w/v) MQ solution, FT-IR measurement results an OH Signal Area of 33.07. The Silanol Index of this MQ resin is 1980, which is equal to 33.07/1.67%.

TABLE 4
Silanol Index values of four MQ resins used in the study,
calculated based on FTIR absorption peaks around 3700 cm⁻¹

| | Silanol Index |
|---|---|
| MQ resins | (Non-Bonded, −3700 cm⁻¹) |
| High SiOH MQ | 1980 |
| MQ A | 1140 |
| MQ B | 960 |
| Low SiOH MQ | 198 |

Film Gloss Measurement

Glossy appearance could be desirable in many color cosmetic applications, including lip loss and lip stick. The test method for understanding color cosmetic films' gloss is briefly described as the following steps:

1. Collagen films (Viscofan from Naturin GmbH & Co.) are secured tightly on 3×2.5 inch hard polycarbonate blocks.
2. About 0.14 grams of each formulation is spread by finger on respective collagen films.
3. The coated films are allowed to dry overnight.
4. A gloss meter (micro-TRI-gloss from BYK-Gardner) was used to measure gloss readings for both 20 degree and 60 degree angles. The higher gloss reading value, the more glossy a film is.
5. The films appearance can also be captured by a digital camera under a controlled lighting. Digital camera image can then be presented to a panel to assess human perception.

### Film Gloss Measurement Results:

A digital image was obtained of two types of cosmetic films (in triplicates) dried on collagen. The top row are dried cosmetic films (in triplicates) made from high Silanol MQ (Silanol Index=1980) based on the formula in Table 1, while the bottom row are dried cosmetic films (in triplicates) made from low Silanol MQ (Silanol Index=198) based on the formula in Table 1. This digital image was shown to 8 panelists to assess which formulation showed more glossiness. Every panelist agreed that the films from formulation containing low Silanol MQ (Silanol Index=198) are more glossy.

Table 5 shows gloss meter readings of different cosmetic films dried on collagen from both 20° and 60° reflecting angles. As related data shown from left to right, the four formulations studied are: high Silanol MQ (Silanol Index=1980) based on the formula in Table 1, high Silanol MQ (Silanol Index=1980) based on the formula in Table 2, low Silanol MQ (Silanol Index=198) based on the formula in Table 1, and low Silanol MQ (Silanol Index=198) based on the formula in Table 2. As the data consistently show, when in combination with silicone gum, low Silanol MQ (Silanol Index=198) resulted in more glossy films than high silanol MQ (Silanol Index=1980).

TABLE 5

| | high-SiOH | high-SiOH | low-SiOH | low-SiOH |
|---|---|---|---|---|
| | MQ: 1 | MQ: 1 | MQ: 1 | MQ: 1 |
| | M cSt gum = | M cSt gum = | M cSt gum = | M cSt gum = |
| | 7.5:2.5 | 6:4 | 7.5:2.5 | 6:4 |
| 20° gloss | 0.25 | 3.4 | 0.74 | 4.6 |
| 60° gloss | 1.63 | 26.9 | 7.78 | 34.5 |

Abrasion Test Setup and Procedure:

Rub-off and transfer resistance are very desirable properties for color cosmetic products. Rub-off and transfer resistance in the presence of sebum are tough technical challenges currently in cosmetic research. The test method for measuring the color cosmetic films' rub-off and sebum resistance properties is briefly described as the following steps:
1. Collagen films (Viscofan from Naturin GmbH & Co.) are secured tightly on 3×2.5 inch hard polycarbonate blocks.
2. About 0.14 grams of each formulation is spread by finger on respective collagen films.
3. The coated films are allowed to dry overnight.
4. For abrasion tests with artificial sebum, each dried cosmetic film on collagen was treated with artificial sebum prior to abrasion test. A small roller (˜1 inch) is used to gently spread ˜0.04 grams of artificial sebum on cosmetic film (coated on collagen). The treated films are left at ambient condition for 3-4 hours before abrasion testing.
5. Abrasion testing on all the artificial treated or non-treated films is conducted by using a modified Gardner Abrasion Tester. Up to 50 abrasion cycles may be applied to each sample. L*a*b values of both sample and white rubbing cloth can be recorded by a colorimeter (HunterLab Colorscan XE) after abrasion cycles. Particularly, the “a” value from L*a*b reading is related to “redness” of the surface and is used to understand red pigment transfer.
6. After abrasion, the visual appearance of both sample and rubbing cloth can also be recorded using digital camera. Digital camera image can then be presented to a human panel to assess human perception.

Abrasion Test Results:

Abrasion tests were also done on formulations based on MQ and silicone polyamide. Digital images of several cosmetic films and abrasion cloths (in duplicate) after 50 abrasion cycles with artificial sebum were obtained. All the formulations were based on the formula in Table 3, with four different type of MQ resins used. The images were presented to 8 human panelists; all panelists agreed that the formulation using low SiOH MQ resin (Silanol Index=198) showed less rub-off, thus most rub-off resistance.

In addition to panel testing of the films, the degrees of color transfer of the four above mentioned formulations were also characterized by colorimeter, which can provide an L*a*b reading to characterize surface color. The “a” value from an L*a*b reading is correlated to the “redness” of an object's color. The higher “a” value, the more “redness” of surface color. For abrasion cloth after abrasion, the lower “a” value, the less red pigment transferred. Table 6 shows “a” values from colorimeter L*a*b readings of white abrasion cloths after 50 abrasion cycles with artificial sebum. The results confirmed that the formulation containing Low Silanol MQ (Silanol Index=198) showed the least color transfer to the white abrasion cloth.

TABLE 6

| | High-SiOH | MQ | MQ | Low-SiOH |
|---|---|---|---|---|
| | MQ | Resin A | Resin B | MQ |
| a value | 10.15 | 7.29 | 6.81 | 5.45 |

Abrasion tests were also done on formulations based on MQ and silicone gum. Four formulations were studied: high Silanol MQ (Silanol Index=1980) based on the formula in Table 1, high Silanol MQ (Silanol Index=1980) based on the formula in Table 2, low Silanol MQ (Silanol Index=198) based on the formula in Table 1, and low Silanol MQ (Silanol Index=198) based on the formula in Table 2. Digital images in duplicate were obtained from both films and cloths after 50 abrasion cycles with and without artificial sebum. Panelists concluded that, after abrasion tests with artificial sebum, formulations with low-silanol MQ resin showed less color transfer than those with high-silanol MQ resins.

In addition to the digital images, the degrees of color transfer of the four above mentioned formulation were also characterized by colorimeter, which can provide an L*a*b reading to characterize surface color. The “a” value from an L*a*b reading is correlated to the “redness” of an object's color. The higher “a” value, the more “redness” of surface color. For abrasion cloth after abrasion, the lower “a” value, the less red pigment transferred. Table 7 shows “a” values from colorimeter L*a*b readings of white abrasion cloths after 50 abrasion cycles with artificial sebum. The colorimeter values, together with visual assessment on the digital camera image, showed that formulations using low SiOH MQ resin had better rub-off resistance, particularly for rub-off testing with artificial sebum.

TABLE 7
a Values from White Abrasion Cloths
(amount of color transfer to cloth)

| | high-SiOH | high-SiOH | low-SiOH | low-SiOH |
|---|---|---|---|---|
| | MQ: 1 | MQ: 1 | MQ: 1 | MQ: 1 |
| | M cst gum = | M cst gum = | M cst gum = | M cst gum = |
| | 7.5:2.5 | 6 :4 | 7.5:2.5 | 6:4 |
| without | 1.4 | 1.3 | 0.6 | 2.9 |
| sebum | | | | |
| with | 19.7 | 17.2 | 3.5 | 11.4 |
| sebum | | | | |

1. A composition comprising:
a) MQ resin having a silanol index no greater than 300; and
b) a polysiloxane having a viscosity of at least 600,000 cSt at 25° C. or a solid silicone polyamide.

2. The composition of claim 1 in which the composition comprises from 2 to 30 wt % of said MQ resin and from 0.5 to 25 wt % of said polysiloxane or silicone polyamide.

3. The composition of claim 2 in which the MQ resin has an M/Q ratio from 0.6:1 to 1.0:1.

4. The composition of claim 3 in which said polysiloxane comprises [RR′SiO_{2/2}] units, where R and R′ are monovalent hydrocarbon radicals containing from 1 to 6 carbon atoms.

5. The composition of claim 4 in which the silicone polyamide the silicone polyamide comprises blocks, each of which comprises a polysiloxane block and an amide.

6. The composition of claim 5 in which the MQ resin has a silanol index no greater than 270.

7. The composition of claim 6 in which the silicone polyamide has formula A 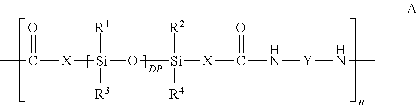
wherein:
(1) DP is 1-700 as a number average value for degree of polymerization of siloxane units;
(2) n is a number from 1-500;
(3) X is a divalent, aliphatic hydrocarbon group having 1-30 carbons;
(4) Y is:
(a) a divalent hydrocarbon group having 1-40 carbons, wherein the hydrocarbon group optionally is substituted by at least one member selected from the group consisting of (i) hydroxy; (ii) a C₃-C₈ cycloalkyl; (iii) 1-3 members selected independently from the group consisting of C₁-C₃ alkyl and phenyl optionally substituted by 1-3 members selected independently from the group consisting of C₁-C₃ alkyl; (iv) a C₁-C₃ hydroxyalkyl; and (v) a C₁-C₆ alkyl amino, and
the hydrocarbon group optionally contains at least one of (i) 1-3 amide linkages; (ii) a C₅ or C₆ cyclic, divalent, saturated hydrocarbon group; and (iii) a phenylene optionally substituted by 1-3 members selected independently from the group consisting of C₁-C₃ alkyl, or
(b) R²⁰T(R²¹)R²², where R²⁰ and R²² are divalent C₁-C₁₀ hydrocarbon groups and R²¹ is a monovalent or divalent C₁-C₁₀ hydrocarbon group, such groups being independent of one another, and T is C(R), where R is selected from hydrogen, R¹, R², R³, R⁴, or a trivalent N, P or Al; and
(5) Each of R¹-R⁴ is independently selected from the group consisting of methyl, ethyl, propyl, isopropyl, a siloxane chain and phenyl, wherein the phenyl optionally is substituted at 1-3 positions by substituents independently selected from the group consisting of methyl and ethyl; more particularly, each of R¹-R⁴ is selected from methyl and ethyl, preferably methyl.

8. The composition of claim 7 in which in which at least 95 wt % of siloxane units in said polysiloxane comprising polyether units are D units.

9. The composition of claim 8 further comprising 5 to 45 wt % of coloring agents and 5 to 50 wt % volatile solvents having viscosity of 0.5 to 50 cp at 25° C.
